(19) United States
(12) Patent Application Publication
(10) Pub. No.: US 2022/0349470 A1
(43) Pub. Date: Nov. 3, 2022

(54) GASKET

(71) Applicant: Ket & Ket Co., Ltd., Nihonmatsu (JP)

(72) Inventor: Nobuo YOSHINO, Nihonmatsu (JP)

(73) Assignee: Ket & Ket Co., Ltd., Nihonmatsu (JP)

(21) Appl. No.: 17/812,659

(22) Filed: Jul. 14, 2022

Related U.S. Application Data
(63) Continuation of application No. PCT/JP2021/001020, filed on Jan. 14, 2021.

(30) Foreign Application Priority Data
Sep. 8, 2020 (JP) 2020150732

(51) Int. Cl. F16J 15/08

(52) U.S. Cl. CPC F16J 15/0818

(57) ABSTRACT

A gasket to be attached between a cylinder head and a cylinder block of an internal combustion engine includes a pair of substrates, an intermediate plate disposed between the pair of substrates, and a spacer disposed between the pair of substrates. Each of the pair of substrates includes a cooling water sealing bead for sealing a cooling water passage surrounding a bore wall formed in the cylinder block. The intermediate plate includes a wedge portion formed in a shape corresponding to a deck surface of the bore wall of the cylinder block so as to be sandwiched between the bore wall and the cylinder head. The spacer is formed so as to extend in a cross direction S crossing an arrangement direction L of boreholes of the cylinder block without overlapping the cooling water sealing bead.

### CROSS REFERENCE TO RELATED APPLICATIONS

The present application is a continuation application of International Patent Application No. PCT/JP2021/001020 filed on Jan. 14, 2021, which claims the benefit of Japanese Patent Application No. 2020-150732, filed on Sep. 8, 2020. The contents of these applications are incorporated herein by reference in their entirety.

### TECHNICAL FIELD

The present disclosure relates to a gasket and, in particular, relates to a gasket used in an internal combustion engine of a vehicle or a general-purpose machine or the like.

### BACKGROUND ART

In an internal combustion engine of a vehicle or a general-purpose machine, for example, an automobile, a gasket is used to seal a gap between a cylinder head and a cylinder block.

Conventional gaskets include those having an upper substrate, a lower substrate, and a shim plate. The upper substrate has formed thereon beads adapted to contact a cylinder head surface and hermetically seal boreholes, oil holes, and cooling water holes, while the lower substrate has formed thereon beads adapted to contact a cylinder block surface and hermetically seal the boreholes, the oil holes, and the cooling water holes. The shim plate has a shape corresponding to a deck surface of a bore wall of the cylinder block surface, and is sandwiched between the upper substrate and the lower substrate, between the cylinder head surface and the deck surface in the usage state.

In the usage state, the gasket seals a gap between the cylinder head surface of the cylinder head and the cylinder block surface of the cylinder block that are fastened together with bolts. Due to the fastening force of such bolts, strain (i.e., fastening strain) may be generated in the cylinder head surface and the cylinder block surface, and if a gasket without a shim plate is used, gaps may be generated around the boreholes. In the usage state, the shim plate increases each of the contact pressure of the upper substrate against the cylinder block surface and the contact pressure of the lower substrate against the deck surface around the boreholes. Accordingly, even if fastening strain is generated, generation of gaps between the upper substrate and the lower substrate and between the cylinder block surface and the deck surface is suppressed, and thus, seal performance around the boreholes of the gasket is improved (for example, Patent Literature 1: Japanese Patent Laid-Open No. 2001-227410).

### SUMMARY OF DISCLOSURE

### Technical Problem

As described above, the shim plate can be intended to suppress the generation of gaps due to fastening strain generated in the cylinder head surface and the cylinder block surface. Meanwhile, when a gasket with a shim plate is used, the cylinder head surface may deform as fastening is made with bolts, which may cause strain around cylinder bores. Further, if the cylinder head surface deforms, the degree of straight movement of the camshaft bearings would decrease.

Such deformation of the cylinder head surface is larger at the ends in the arrangement direction of the cylinder bores, and thus, considerable strain is generated around the cylinder bores at the ends in the arrangement direction of the cylinder bores. For example, in a four-cylinder internal combustion engine, considerable strain is generated around the first and fourth cylinder bores.

As described above, for a conventional gasket with a shim plate, a configuration has been desired that can suppress deformation of a cylinder head due to the fastening force of bolts in the usage state, and thus can suppress deformation of cylinder bores and camshaft bearings.

The present disclosure has been made in view of the problems described above, and it is an object of the present disclosure to provide a gasket in which deformation of a cylinder head due to the fastening force of bolts can be suppressed.

### Solution to Problem

To achieve the aforementioned object, a gasket according to the present disclosure is a gasket to be attached between a cylinder head and a cylinder block of an internal combustion engine, including a pair of substrates; an intermediate plate disposed between the pair of substrates; and a spacer disposed between the pair of substrates, in which each of the pair of substrates includes a cooling water sealing bead as a bead portion for sealing a cooling water passage surrounding a bore wall formed in the cylinder block, the intermediate plate includes a wedge portion as a portion formed in a shape corresponding to a deck surface of the bore wall of the cylinder block so as to be sandwiched between the bore wall and the cylinder head, and the spacer is formed so as to extend in a cross direction crossing an arrangement direction of boreholes of the cylinder block without overlapping the cooling water sealing bead, and be sandwiched between the cylinder block and the cylinder head at each end in the arrangement direction of the boreholes.

In the gasket according to an aspect of the present disclosure, a plate thickness of the spacer is less than or equal to a plate thickness of the wedge portion of the intermediate plate.

In the gasket according to an aspect of the present disclosure, the spacer at each end has a pair of through-holes opposed in the cross direction, the pair of through-holes corresponding to a pair of bolt holes of the cylinder head and a pair of bolt holes of the cylinder block.

In the gasket according to an aspect of the present disclosure, the spacer is fixed to the pair of substrates through riveting or swaging.

In the gasket according to an aspect of the present disclosure, the spacer is joined to one of the pair of substrates.

In the gasket according to an aspect of the present disclosure, the spacer is provided with a protruding portion along the extension direction of the spacer, the protruding portion being a portion protruding toward one of the pair of substrates, and the spacer is joined to the one of the pair of substrates at the protruding portion.

In the gasket according to an aspect of the present disclosure, the intermediate plate includes an intermediate-plate overhanging portion as a portion protruding to a side of the cooling water passage, and the spacer is joined to the intermediate-plate overhanging portion.

In the gasket according to an aspect of the present disclosure, the spacer includes a spacer overhanging portion as a portion protruding to the side of the cooling water passage, the intermediate plate and the spacer are joined together at the intermediate-plate overhanging portion and the spacer overhanging portion, and a portion where the intermediate-plate overhanging portion and the spacer overhanging portion are joined together overlaps the cooling water passage.

In the gasket according to an aspect of the present disclosure, the intermediate-plate overhanging portion extends beyond the cooling water passage.

### Effect of Disclosure

With the gasket according to the present disclosure, deformation of a cylinder head can be suppressed.

### BRIEF DESCRIPTION OF DRAWINGS

FIG. 1 A schematic perspective view showing a four-cylinder internal combustion engine provided with a gasket according to a first embodiment of the present disclosure in a state where a cylinder head is removed.

FIG. 2 A cross-sectional view showing the gasket along line A-A of FIG. 1, inclusive of a cylinder head and a cylinder block.

FIG. 3 A cross-sectional view showing the gasket along line B-B of FIG. 1.

FIG. 4 A schematic perspective view showing one end of a gasket according to a second embodiment of the present disclosure.

FIG. 5 A cross-sectional view showing the gasket along line C-C of FIG. 4, inclusive of a cylinder head and a cylinder block.

FIG. 6 A schematic perspective view showing one end portion of a gasket according to a modified example of the second embodiment of the present disclosure in the arrangement direction.

FIG. 7 A cross-sectional view showing the gasket along line D-D of FIG. 6, inclusive of a cylinder head and a cylinder block.

FIG. 8 A schematic perspective view showing one end of a gasket according to a third embodiment of the present disclosure in the arrangement direction.

FIG. 9 A cross-sectional view showing the gasket along line E-E of FIG. 8, inclusive of a cylinder head and a cylinder block.

FIG. 10 A schematic perspective view showing an end portion at one end of a gasket according to a modified example of the third embodiment of the present disclosure in the arrangement direction.

FIG. 11 A cross-sectional view showing the gasket along line F-F of FIG. 10, inclusive of a cylinder head and a cylinder block.

FIG. 12 A cross-sectional view showing an internal combustion engine provided with a gasket according to a fourth embodiment of the present disclosure, inclusive of a cylinder head and a cylinder block.

FIG. 13 A cross-sectional view showing an internal combustion engine provided with a gasket according to a fifth embodiment of the present disclosure, inclusive of a cylinder head and a cylinder block.

### DESCRIPTION OF EMBODIMENTS

Hereinafter, embodiments of the present disclosure will be described with reference to the drawings.

### First Embodiment

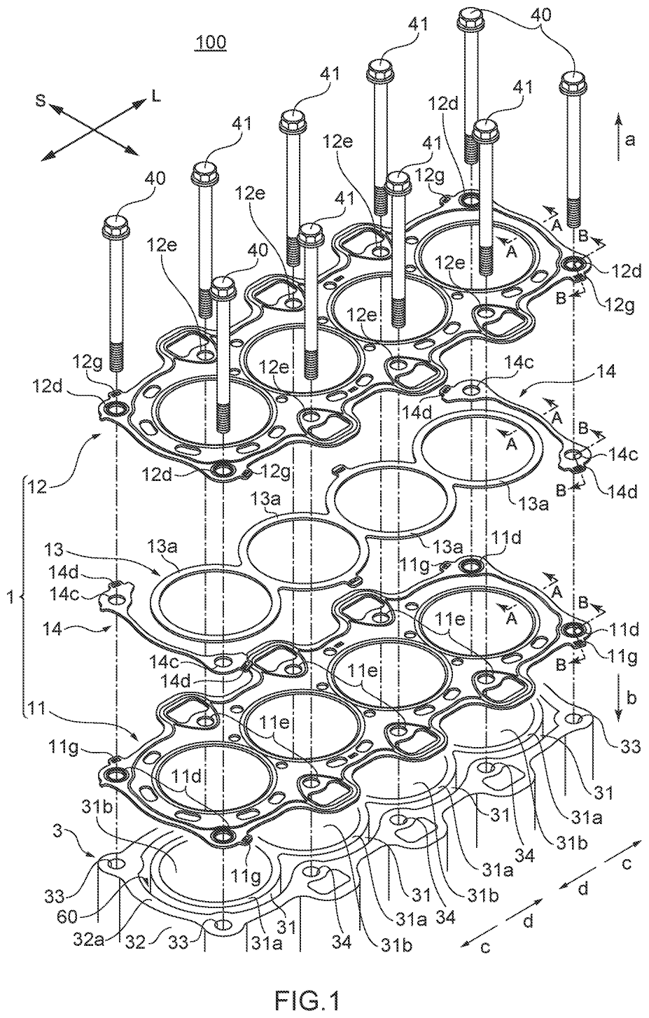

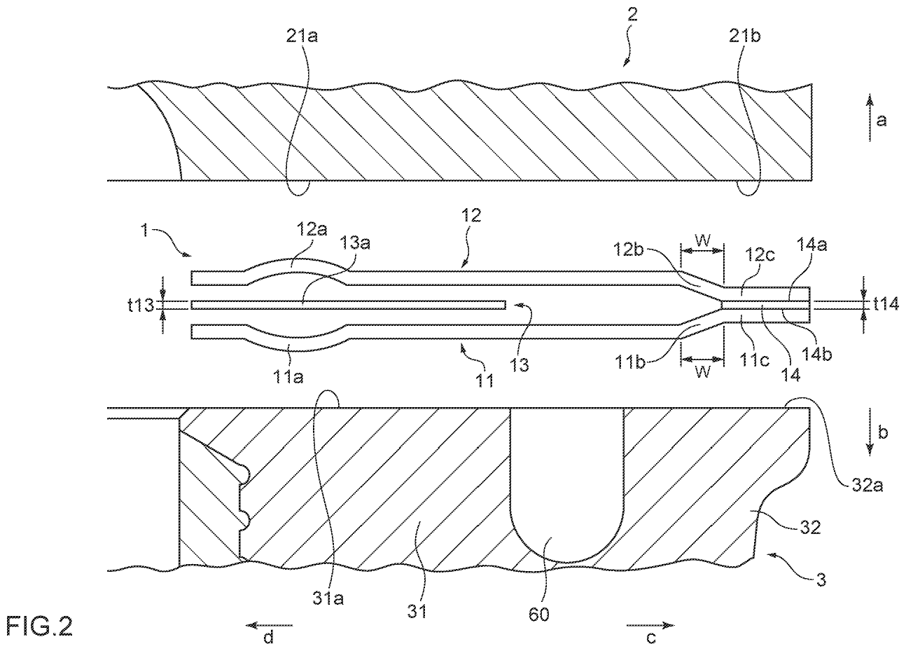

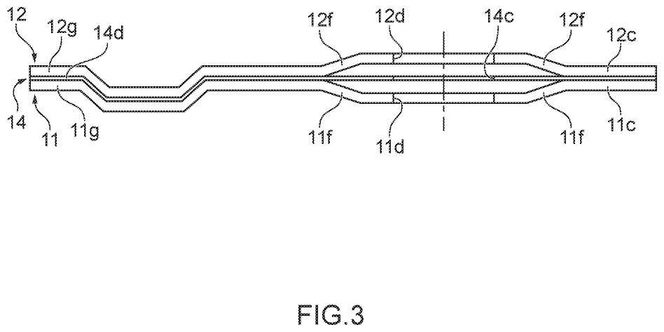

FIG. 1 is a schematic perspective view showing a four-cylinder internal combustion engine 100 provided with a gasket 1 according to a first embodiment of the present disclosure in a state where a cylinder head 2 is removed. FIG. 2 is a cross-sectional view showing the gasket 1 along line A-A of FIG. 1, inclusive of the cylinder head 2 and a cylinder block 3. FIG. 3 is a cross-sectional view of the gasket 1 along line B-B of FIG. 1. In the following description, the upper side or upward direction (i.e., the direction of an arrow a in FIGS. 1 and 2) is the side or direction on/in which the cylinder head 2 is provided in the internal combustion engine 100, while the lower side or downward direction (i.e., the direction of an arrow b in FIGS. 1 and 2) is the side or direction on/in which the cylinder block 3 is provided in the internal combustion engine 100. In addition, the outer side or outward direction (i.e., the direction of an arrow c in FIGS. 1 and 2) is the outer side or outward direction of the cylinder block 3 along the direction L in which boreholes 31b described below of the cylinder block 3 are disposed (hereinafter referred to as an arrangement direction L), while the inner side or inward direction (i.e., the direction of an arrow d in FIGS. 1 and 2) is the inner side or inward direction of the cylinder block 3 along the arrangement direction L.

The gasket 1 according to the first embodiment of the present disclosure is attached between the cylinder head 2 and the cylinder block 3 of the internal combustion engine 100. The gasket 1 includes a pair of substrates 11 and 12, an intermediate plate (hereinafter also referred to as a “shim plate”) 13 disposed between the pair of substrates 11 and 12, and a spacer 14 disposed between the pair of substrates 11 and 12. The pair of substrates 11 and 12 respectively have cooling water sealing beads 11b and 12b as bead portions for sealing a cooling water passage 60 surrounding a bore wall 31 formed in the cylinder block 3. The intermediate plate 13 has wedge portions 13a as portions each formed in a shape corresponding to a deck surface 31a of each bore wall 31 of the cylinder block 3 so as to be sandwiched between the bore wall 31 and the cylinder head 2. The spacer 14 is formed so as to extend in a cross direction S crossing the arrangement direction L of the boreholes 31b of the cylinder block 3 without overlapping the cooling water sealing bead 11b or 12b and be sandwiched between the cylinder block 3 and the cylinder head 2 at each end in the arrangement direction L of the boreholes 31b. Hereinafter, the gasket 1 will be specifically described.

The lower substrate 11 is a flat substrate disposed on the side of the cylinder block 3. The lower substrate 11 has a bead 11a as an annular bead portion. The bead 11a is formed so as to face the annular deck surface 31a of each bore wall 31 of the cylinder block 3 in the usage state of the gasket 1. The bead 11a is a full bead, and is formed such that it protrudes convex in an arc shape toward the cylinder block 3 so as to form a step and thus apply a predetermined contact pressure to the deck surface 31a of the cylinder block 3 in the usage state of the gasket 1.

The lower substrate 11 has the cooling water sealing bead 11b. The cooling water sealing bead 11b seals the cooling water passage 60 surrounding the bore wall 31 formed in the cylinder block 3. The cooling water sealing bead 11b extends so as to face an outer upper surface 32a of the cylinder block 3 in the usage state of the gasket 1. The cooling water sealing bead 11b is a half bead, and is formed such that it protrudes convex in an arc shape toward the cylinder block 3 so as to form a step and thus apply a predetermined contact pressure to the outer upper surface 32a of the cylinder block 3 in the usage state of the gasket 1. The width and height of the cooling water sealing bead 11b are set so as to generate the predetermined contact pressure.

The lower substrate 11 is specifically a plate-like member with a constant or substantially constant thickness. The lower substrate 11 extends outward from an end portion on the outer side of the bead 11a, and is formed such that it bends at a position facing the outer upper surface 32a of an outer wall 32 of the cylinder block 3 and then extends in an inclined manner in the usage state of the gasket 1. The cooling water sealing bead 11b is formed at the position of the lower substrate 11 facing the outer upper surface 32a.

The lower substrate 11 has an outer edge portion 11c. The outer edge portion 11c is a flat portion extending further outward from an end portion on the outer side of the cooling water sealing bead 11b. The outer edge portion 11c is formed so as to face the outer upper surface 32a of the outer wall 32 and is formed so as to extend in an annular shape along the outer upper surface 32a of the outer wall 32 in the usage state of the gasket 1.

The lower substrate 11 has a plurality of insertion holes (i.e., through-holes) 11d and 11e formed therein. The insertion holes 11d are formed at opposite ends in the arrangement direction L and at opposite ends in the cross direction S crossing the arrangement direction L. The cross direction S is specifically a direction perpendicular to the arrangement direction L. The insertion holes 11d are adapted to pass end-portion bolts 40 provided at opposite ends in the arrangement direction L among the bolts 40 and 41. The insertion holes 11d are formed in the outer edge portion 11c at positions on the outer side of the cooling water sealing bead 11b. The insertion holes 11e are adapted to pass the inner-side bolts 41 provided on the inner side in the arrangement direction L among the bolts 40 and 41.

The lower substrate 11 has a bead 11f as an annular bead portion around each insertion hole 11d. The bead 11f is formed so as to surround each end-portion bolt hole 33 described below of the outer wall 32 of the cylinder block 3 in the usage state of the gasket 1. The bead 11f is a half bead, and is formed such that it protrudes toward the cylinder block 3 so as to form a step and thus apply a predetermined contact pressure to the outer upper surface 32a of the cylinder block 3 in the usage state of the gasket 1.

The end-portion bolts 40 are inserted through the end-portion bolt holes 33 formed at opposite ends of the cylinder block 3 in the arrangement direction L and at opposite ends thereof in the cross direction S crossing the arrangement direction L. The plurality of insertion holes 11e are provided between respective pairs of opposite insertion holes 11d in the arrangement direction L. The insertion holes 11e are adapted to pass the inner-side bolts 41 provided on the inner side in the arrangement direction L among the bolts 40 and 41. The inner-side bolts 41 are inserted through inner-side bolt holes 34 formed between the end bolt holes 33 of the cylinder block 3 in the arrangement direction L.

The lower substrate 11 has protruding portions 11g as fixing members described below. For example, the lower substrate 11 has a plurality of protruding portions 11g at opposite ends in the arrangement direction L. The protruding portions 11g are portions provided around the respective insertion holes 11d and protruding substantially in the cross direction S, for example. The lower substrate 11 is formed so as to be fixed to the upper substrate 12 and the spacer 14 described below at each protruding portion 11g. It should be noted that the protruding portions 11g may face the outer upper surface 32a of the outer wall 32 of the cylinder block 3 or extend beyond the outer upper surface 32a in the cross direction S in the usage state of the gasket 1.

The upper substrate 12 is a flat substrate disposed on the side of the cylinder head 2. The upper substrate 12 has a bead 12a as an annular bead portion. The bead 12a is formed so as to face a cylinder head surface 21a of the cylinder head 2, which is a surface facing each deck surface 31a of the cylinder block 3, in the usage state of the gasket 1. The bead 12a is a full bead, and is formed such that it protrudes convex in an arc shape toward the cylinder head 2 so as to form a step and thus apply a predetermined contact pressure to the cylinder head surface 21a in the usage state of the gasket 1.

The upper substrate 12 has the cooling water sealing bead 12b. The cooling water sealing bead 12b seals the cooling water passage 60 surrounding the bore wall 31 formed in the cylinder block 3. The cooling water sealing bead 12b extends so as to face an outer lower surface 21b of the cylinder head 2 which is a surface facing the outer upper surface 32a. The cooling water sealing bead 12b is a half bead, and is formed such that it protrudes convex in an arc shape toward the cylinder head 2 so as to form a step and thus apply a predetermined contact pressure to the outer lower surface 21b of the cylinder head 2 in the usage state of the gasket 1. The width and height of the cooling water sealing bead 12b are set so as to generate the predetermined contact pressure.

The upper substrate 12 is specifically a plate-like member with a constant or substantially constant thickness. The upper substrate 12 extends from an end portion on the outer side of the bead 12a to the side of the outer lower surface 21b of the cylinder head 2, and is formed such that it bends at a position facing the outer lower surface 21b and then extends in an inclined manner in the usage state of the gasket. The cooling water sealing bead 12b is formed at the position of the upper substrate 12 facing the outer lower surface 21b.

The upper substrate 12 has an outer edge portion 12c. The outer edge portion 12c is a flat portion extending further outward from an end portion on the outer side of the cooling water sealing bead 12b. The outer edge portion 12c is formed so as to face the outer lower surface 21b of the cylinder head 2, and is formed so as to extend in an annular shape along the outer lower surface 21b of the cylinder head 2.

The upper substrate 12 has a plurality of insertion holes (i.e., through-holes) 12d and 12e formed therein. The insertion holes 12d are formed at opposite ends in the arrangement direction L and at opposite ends in the cross direction S crossing the arrangement direction L. The cross direction S is specifically a direction perpendicular to the arrangement direction L. The insertion holes 12d are adapted to pass the end-portion bolts 40 provided at opposite ends in the arrangement direction L among the bolts 40 and 41. The insertion holes 12d are formed in the outer edge portion 12c at positions on the outer side of the cooling water sealing bead 12b. The insertion holes 12e are adapted to pass the inner-side bolts 41 provided on the inner side in the arrangement direction L among the bolts 40 and 41.

The upper substrate 12 has a bead 12f as an annular bead portion around each insertion hole 12d. The bead 12f is formed so as to surround each end bolt hole 33 of the outer wall 32 of the cylinder block 3 in the usage state of the gasket 1. The bead 12f is a half bead, and is formed such that it protrudes toward the cylinder head 2 so as to form a step and thus apply a predetermined contact pressure to the outer lower surface 21b of the cylinder head 2 in the usage state of the gasket 1.

It should be noted that a total of four end-portion bolts 40 are disposed at opposite ends (i.e., on the outer side) in the arrangement direction L. A total of six inner-side bolts 41 are disposed in the arrangement direction L between the end-portion bolts 40. As illustrated in FIG. 2, the width W of each of the cooling water sealing bead 11b and the cooling water sealing bead 12b along the arrangement direction L in the portion where the spacer 14 is disposed is narrower than the width (not illustrated) in the portion in which the spacer 14 is not disposed.

The upper substrate 12 has a plurality of protruding portions 12g as fixing members described below at opposite ends in the arrangement direction L, for example. The protruding portions 12g are portions provided around the respective insertion holes 12d and protruding substantially in the cross direction S, for example. The upper substrate 12 is formed so as to be fixed to the lower substrate 11 and to the spacer 14 described below at each protruding portion 12g. It should be noted that the protruding portions 12g may face the outer lower surface 21b of the cylinder head 2 or extend beyond the outer lower surface 21b in the cross direction S in the usage state of the gasket 1.

The shim plate 13 is a flat plate disposed between the lower substrate 11 and the upper substrate 12. The shim plate 13 has a plurality of wedge portions 13a coupled together in the arrangement direction L. Each wedge portion 13a is formed in a shape corresponding to the deck surface 31a of each bore wall 31 in the usage state of the gasket 1, and is also formed so as to be located between the bead 11a of the lower substrate 11 and the bead 12a of the upper substrate 12. Each wedge portion 13a extends in an annular shape along the deck surface 31a in the usage state of the gasket 1.

The spacer 14 is a flat or substantially flat member, and is formed so as to extend along an opposed portion of the outer upper surface 32a of the outer wall 32 of the cylinder block 3, which defines the cooling water passage 60 together with the bore wall 31 in the arrangement direction L of the wedge portions 13a of the shim plate 13 in the usage state of the gasket 1, and, at such a portion, the spacer 14 is disposed within a predetermined distance from the shim plate 13. The thickness (i.e., plate thickness) t14 of the spacer 14 may be the same or substantially the same as the thickness (i.e., plate thickness) t13 of each wedge portion 13a, and may be thinner than the thickness t13 of the wedge portion 13a (t14<t13). Herein, the thickness t14 of the spacer 14 is the width (i.e., dimension) between a surface (i.e., a lower surface 14b) of the spacer 14 facing the lower substrate 11 and a surface (i.e., an upper surface 14a) thereof facing the upper substrate 12. In addition, the thickness t13 of each wedge portion 13a is a value obtained by measuring the thickness of the shim plate 13 between the lower surface 14b and the upper surface 14a.

The spacer 14 is formed such that it is disposed between the outer edge portion 11c of the lower substrate 11 and the outer edge portion 12c of the upper substrate 12 so as not to overlap the cooling water sealing bead 11b of the lower substrate 11 and the cooling water sealing bead 12b of the upper substrate 12 on the outer lower surface 21b of the cylinder head 2 and the outer upper surface 32a of the cylinder block 3 in the usage state of the gasket 1. That is, the spacer 14 is formed such that it is disposed at a position not sandwiched between the cooling water sealing bead 11b of the lower substrate 11 and the cooling water sealing bead 12b of the upper substrate 12 in the usage state of the gasket 1. It should be noted that the spacer 14 may partially extend beyond the outer upper surface 32a of the cylinder block 3 and the outer lower surface 21b of the cylinder head 2 in the usage state of the gasket 1.

The spacer 14 has a shape corresponding to each of the outer edge portion 11c of the lower substrate 11 and the outer edge portion 12c of the upper substrate 12 in the arrangement direction L, for example. Specifically, the spacer 14 extends between the insertion holes 11d of the lower substrate 11 and the insertion holes 12d of the upper substrate 12 in the cross direction S crossing the arrangement direction L. The spacer 14 has formed therein a pair of insertion holes (i.e., through-holes) 14c such that they overlap the insertion holes 11d of the lower substrate 11, the insertion holes 12d of the upper substrate 12, and the end bolt holes 33 in the usage state of the gasket 1. The insertion holes 14c are formed at opposite ends of the spacer 14 in the cross direction S. In the usage state of the gasket 1, the end-portion bolts 40 are inserted through the respective insertion holes 14c. It should be noted that the spacer 14 may be provided with a single insertion hole 14c corresponding to a single end bolt hole 33.

The spacer 14 has protruding portions 14d corresponding to the protruding portions 11g and the protruding portions 12g. Specifically, the spacer 14 has the protruding portions 14d as portions provided around the respective insertion holes 14c and protruding substantially in the cross direction S. The protruding portions 14d are formed so as to protrude in opposite directions along the cross direction S. The spacer 14 is formed so as to be fixed to the lower substrate 11 and the upper substrate 12 at each protruding portion 14d.

Next, the function of the aforementioned gasket 1 according to the first embodiment of the present disclosure is described. The gasket 1 is fixed as an integral body with the shim plate 13 and the spacer 14 sandwiched between the lower substrate 11 and the upper substrate 12 in a mutually overlapping state. At this time, each wedge portion 13a of the shim plate 13 is disposed between each bead 11a of the lower substrate 11 and each bead 12a of the upper substrate 12. In addition, each spacer 14 is disposed between the outer edge portion 11c of the lower substrate 11 and the outer edge portion 12c of the upper substrate 12 on the outer side of the cooling water sealing bead 11b of the lower substrate 11 and the cooling water sealing bead 12b of the upper substrate 12 so as not to overlap the cooling water sealing bead 11b of the lower substrate 11 and the cooling water sealing bead 12b of the upper substrate 12.

In the gasket 1, the spacer 14 is fixed to the lower substrate 11 and the upper substrate 12. Specifically, the protruding portions 11g, 14d, and 12g of the lower substrate 11, the spacer 14, and the upper substrate 12, respectively, that correspond to one another in the arrangement direction L are overlaid one on top of the other, and the overlaid protruding portions 11g, 14d, and 12g are fixed together through riveting or swaging, for example. In the state in which the lower substrate 11, the upper substrate 12, and the spacer 14 are fixed together, the protruding portions 11g, 12g, 14d of the lower substrate 11, the upper substrate 12, and the spacer 14, respectively, are inclined toward the end bolt holes 33 of the cylinder block 3 at positions facing the end bolt holes 33 in the usage state of the gasket 1, for example. It should be noted that the spacer 14 may be fixed to at least one of the lower substrate 11 and the upper substrate 12 or may be fixed to neither of them.

The gasket 1 formed as an integral body in this manner is placed on a predetermined position of the cylinder block 3. Specifically, the gasket 1 is placed such that as illustrated in FIGS. 1 and 2, the cooling water sealing bead 11b of the lower substrate 11 is disposed on the outer upper surface 32a of the cylinder block 3, and each bead 11a of the lower substrate 11 is disposed on the deck surface 31a of each bore wall 31. The gasket 1 is placed on the cylinder block 3 such that each of the insertion holes 11d of the lower substrate 11 and the insertion holes 12d of the upper substrate 12 communicates with each of the end bolt holes 33 formed in the outer upper surface 32a of the cylinder block 3. At this time, dowel pins (not illustrated) may be inserted into two of the end bolt holes 33 of the cylinder block 3 in advance. As the dowel pins penetrate through the insertion holes 11d and the insertion holes 12d corresponding to the respective end bolt holes 33, positioning of the cylinder head 2 and the gasket 1 with respect to the cylinder block 3 is carried out.

In the state in which the gasket 1 is placed on the cylinder block 3 as described above, the end bolts 40 and the inner-side bolts 41 are penetrated through predetermined bolt holes provided in the cylinder head 2 (not illustrated in FIG. 1), the insertion holes 12d of the upper substrate 12, the insertion holes 14c of the spacer 14, and the insertion holes 11d of the lower substrate 11, and are screwed into female screw threads formed in the bolt holes 33 of the cylinder block 3.

In the usage state of the gasket 1, each spacer 14 is located around a portion of the outer upper surface 32a at each of opposite ends in the arrangement direction L. That is, each spacer 14 is sandwiched between the cylinder head 2 and the cylinder block 3 via the outer edge portion 12c of the upper substrate 12 and the outer edge portion 11c of the lower substrate 11 around the portion of the outer upper surface 32a at each of the opposite ends in the arrangement direction L. Accordingly, deformation of a portion of the cylinder head 2, which faces the portion of the outer upper surface 32a at each of the opposite ends in the arrangement direction L, toward the outer upper surface 32a is suppressed, which would otherwise occur due to the axial force of the end bolts 40. Therefore, non-uniform deformation of the cylinder head 2 at the opposite ends in the arrangement direction L can be suppressed, and thus, generation of fastening strain in the cylinder head 2 can be suppressed. This can suppress a decrease in the sealing performance for the gap between the cylinder head 2 and the cylinder block 3.

The spacer 14 is disposed between the lower substrate 11 and the upper substrate 12 so as not to overlap the cooling water sealing bead 11b of the lower substrate 11 or the cooling water sealing bead 12b of the upper substrate 12. Accordingly, there is no possibility that the spacer 14 will influence the functions of the bead 11b of the lower substrate 11 and the bead 12b of the upper substrate 12. Thus, it is possible to secure the desired deformation of the entire cooling water sealing beads 11b and 12b, and thus achieve the desired sealing for the gap between the outer upper surface 32a of the cylinder block 3 and the outer lower surface 21b of the cylinder head 2.

As described above, with the gasket 1 according to the first embodiment of the present disclosure, deformation of the cylinder head 2 due to the fastening force of the bolts 40 and 41 can be suppressed.

### Second Embodiment

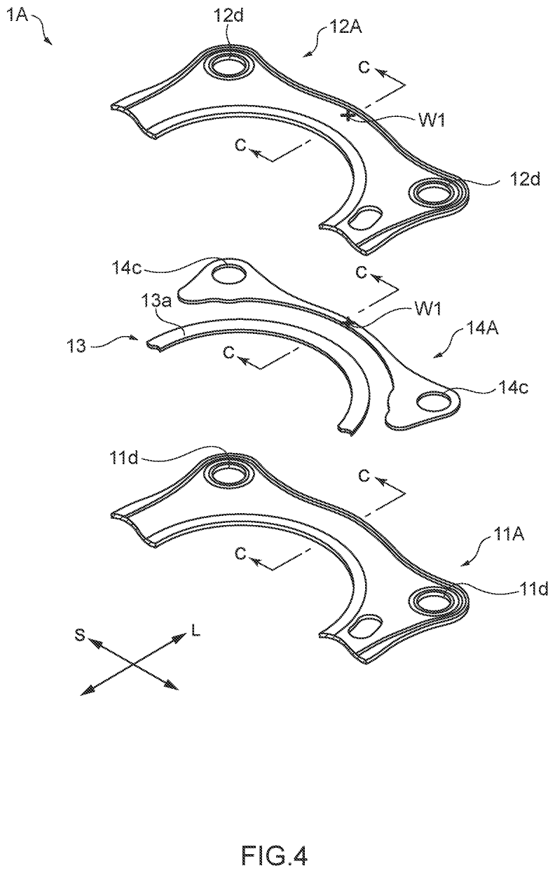

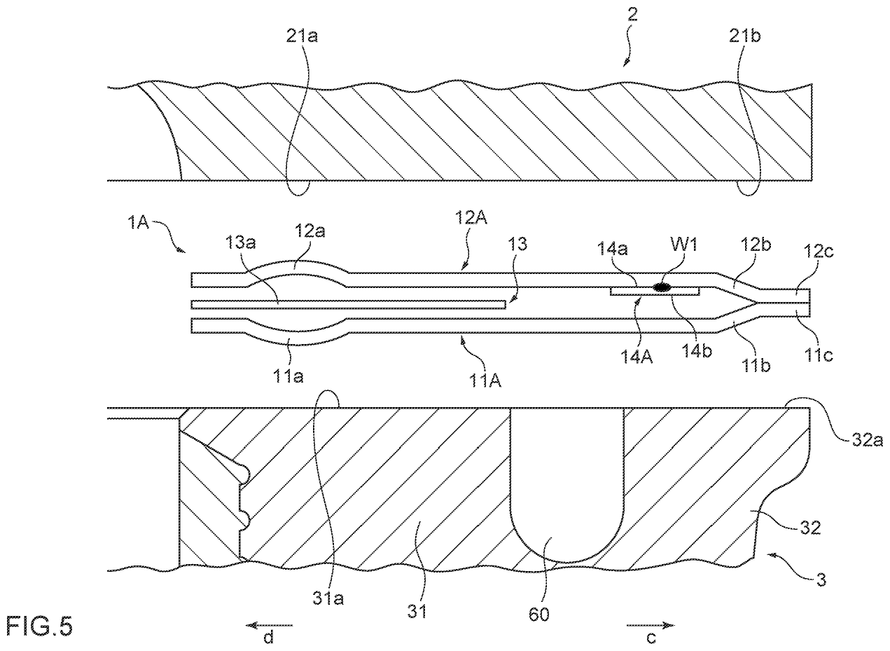

FIG. 4 is a schematic perspective view showing one end of a gasket 1A according to a second embodiment of the present disclosure. FIG. 5 is a cross-sectional view showing the gasket 1A along line C-C of FIG. 4, inclusive of a cylinder head 2 and a cylinder block 3. It should be noted that in FIGS. 4 and 5, portions corresponding to those in FIGS. 1 and 2 are denoted by the same reference signs as those in FIGS. 1 and 2. Hereinafter, parts different from those in the first embodiment will be mainly described.

The gasket 1A according to the second embodiment of the present disclosure is attached between the cylinder head 2 and the cylinder block 3 of the internal combustion engine. The gasket 1A includes a pair of substrates 11A and 12A, a shim plate (i.e., an intermediate plate) 13 disposed between the pair of substrates 11A and 12A, and a spacer 14A disposed between the pair of substrates 11A and 12A.

The lower substrate 11A is a flat substrate disposed on the side of the cylinder block 3. The lower substrate 11A has an annular bead 11a and a cooling water sealing bead 11b. The cooling water sealing bead 11b seals a cooling water passage 60 surrounding a bore wall 31 formed in the cylinder block 3. The cooling water sealing bead 11b extends so as to face an outer upper surface 32a of the cylinder block 3 in the usage state of the gasket 1A. The cooling water sealing bead 11b is a half bead, and is formed such that it protrudes in a convex manner toward the cylinder head 2 so as to form a step and thus apply a predetermined contact pressure to the outer upper surface 32a of the cylinder block 3 in the usage state of the gasket 1A.

The lower substrate 11A has an outer edge portion 11c. The outer edge portion 11c is a flat portion extending further outward from an end portion on the outer side of the cooling water sealing bead 11b. The outer edge portion 11c is formed so as to face the outer upper surface 32a of the outer wall 32 and is also formed so as to extend in an annular shape along the outer upper surface 32a of the outer wall 32 in the usage state of the gasket 1. The lower substrate 11A has insertion holes (i.e., through-holes) 11d formed therein. The insertion holes 11d are adapted to pass end bolts 40. The insertion holes 11d are formed on the inner side of the cooling water sealing bead 11b. The lower substrate 11A further has formed therein insertion holes corresponding to the insertion holes 11e in the first embodiment, for passing inner-side bolts 41.

The upper substrate 12A has an annular bead 12a and a cooling water sealing bead 12b. The cooling water sealing bead 12b seals the cooling water passage 60 surrounding the bore wall 31 formed in the cylinder block 3. The cooling water sealing bead 12b extends so as to face the outer lower surface 21b of the cylinder head 2 in the usage state of the gasket 1A. The cooling water sealing bead 12b is a half bead, and is formed such that it protrudes in a convex manner toward the cylinder block 3 so as to form a step and thus apply a predetermined contact pressure to the outer lower surface 21b of the cylinder head 2 in the usage state of the gasket 1A.

The upper substrate 12A has an outer edge portion 12c. The outer edge portion 12c is a flat portion extending further outward from an end portion on the outer side of the cooling water sealing bead 12b. The outer edge portion 12c is formed so as to face the outer lower surface 21b of the cylinder head 2, and is also formed so as to extend in an annular shape along the outer lower surface 21b of the cylinder head 2 in the usage state of the gasket 1A. The upper substrate 12A has insertion holes (i.e., through-holes) 12d formed therein. The insertion holes 12d are adapted to pass the end bolts 40. The insertion holes 12d are formed on the inner side of the cooling water sealing bead 12b. The upper substrate 12A further has formed therein insertion holes corresponding to the insertion holes 12e in the first embodiment for passing the inner-side bolts 41.

Next, the function of the aforementioned gasket 1A according to the second embodiment of the present disclosure will be described. The gasket 1A is fixed as an integral body with the shim plate 13 and the spacer 14A sandwiched between the lower substrate 11A and the upper substrate 12A in a mutually overlapping state. At this time, each wedge portion 13a of the shim plate 13 is disposed between each bead 11a of the lower substrate 11A and each bead 12a of the upper substrate 12A. In addition, each spacer 14A is disposed on the inner side of each of the cooling water sealing bead 11b of the lower substrate 11A and the cooling water sealing bead 12b of the upper substrate 12A in the arrangement direction L so as not to overlap the cooling water sealing bead 11b of the lower substrate 11A or the cooling water sealing bead 12b of the upper substrate 12A.

In the gasket 1A, if the lower substrate 11A and the upper substrate 12A are aftercoated, the spacer 14A is joined to the upper substrate 12A at a junction W1 such that it faces the outer upper surface 32a of the cylinder block 3. The spacer 14A is joined to the upper substrate 12A at the junction W1 through welding, such as spot welding, for example. The spacer 14A is joined to the upper substrate 12A such that an end portion on the outer side of the spacer 14A does not reach the cooling water sealing bead 12b of the upper substrate 12A. That is, the spacer 14A is joined to the upper substrate 12A so as not to be sandwiched between the cooling water sealing bead 11b of the lower substrate 11A and the cooling water sealing bead 12b of the upper substrate 12A. The lower substrate 11A and the upper substrate 12A contact each other at their outer edge portions 11c and 12c. As the spacer 14A is joined to the upper substrate 12A, attachment of the gasket 1A is facilitated. It should be noted that the spacer 14A may be joined to not the upper substrate 12A but rather to the lower substrate 11A through welding, such as spot welding, for example. Herein, the term “aftercoating” refers to a process of coating the lower substrate 11A and the upper substrate 12A with elastic layers each made of a heat-resisting rubber-like elastic material (i.e., a rubber material or a synthetic resin material with rubber-like elasticity) after stamping the lower substrate 11A and the upper substrate 12A into predetermined shapes, and forming the beads 11a and 12a and the cooling water sealing beads 11b and 12b on the lower substrate 11A and the upper substrate 12A, respectively, through embossing.

The gasket 1A formed as an integral body in this manner is placed on a predetermined position of the cylinder block 3. Specifically, the gasket 1A is placed such that the cooling water sealing bead 11b of the lower substrate 11A faces the outer upper surface 32a of the cylinder block 3, and each bead 11a of the lower substrate 11A faces the deck surface 31a of each bore wall 31. The gasket 1A is placed on the cylinder block 3 such that each of the insertion holes 11d of the lower substrate 11A, the insertion holes 12d of the upper substrate 12A, and the insertion holes 14c of the spacer 14A communicates with each of the end bolt holes 33 formed in the outer upper surface 32a of the cylinder block 3. At this time, dowel pins (not illustrated) may be inserted into two of the end-portion bolt holes 33 of the cylinder block 3 in advance. As the dowel pins penetrate through the insertion holes 11d, the insertion holes 12d, and the insertion holes 14c corresponding to the respective end-portion bolt holes 33, positioning of the cylinder head 2 and the gasket 1A with respect to the cylinder block 3 is carried out.

In the state where the gasket 1A is placed on the cylinder block 3 as described above, the end bolts 40 and the inner-side bolts 41 are penetrated through predetermined bolt holes provided in the cylinder head 2, the insertion holes 12d of the upper substrate 12A, the insertion holes 14c of the spacer 14A, and the insertion holes 11d of the lower substrate 11A, and are screwed into female screw threads formed in the bolt holes 33 of the cylinder block 3.

In the usage state of the gasket 1A, each spacer 14A is located around a portion of the outer upper surface 32a at each of opposite ends in the arrangement direction L. That is, each spacer 14A is sandwiched between the cylinder head 2 and the cylinder block 3 via the outer edge portion 12c of the upper substrate 12A and the outer edge portion 11c of the lower substrate 11A around the portion of the outer upper surface 32a at each of the opposite ends in the arrangement direction L. Accordingly, deformation of a portion of the cylinder head 2, which faces the portion of the outer upper surface 32a at each of the opposite ends in the arrangement direction L, toward the outer upper surface 32a is suppressed, which would otherwise occur due to the axial force of the end bolts 40. Therefore, non-uniform deformation of the cylinder head 2 at the opposite ends in the arrangement direction L can be suppressed, and thus, generation of fastening strain in the cylinder head 2 can be suppressed. This can suppress a decrease in the sealing performance for the gap between the cylinder head 2 and the cylinder block 3.

Since the spacer 14A is joined to the upper substrate 12A such that an end portion on the outer side of the spacer 14A in the arrangement direction L does not reach the cooling water sealing bead 12b of the upper substrate 12A, it is possible to secure constant deformation of the entire cooling water sealing bead 12b and the entire cooling water sealing bead 11b of the lower substrate 11A, and thus achieve desired sealing for the gap between the outer upper surface 32a of the cylinder block 3 and the outer lower surface 21b of the cylinder head 2.

As described above, with the gasket 1A according to the second embodiment of the present disclosure, deformation of the cylinder head 2 due to the fastening force of the bolts 40 and 41 can be suppressed.

### Modified Example of Second Embodiment

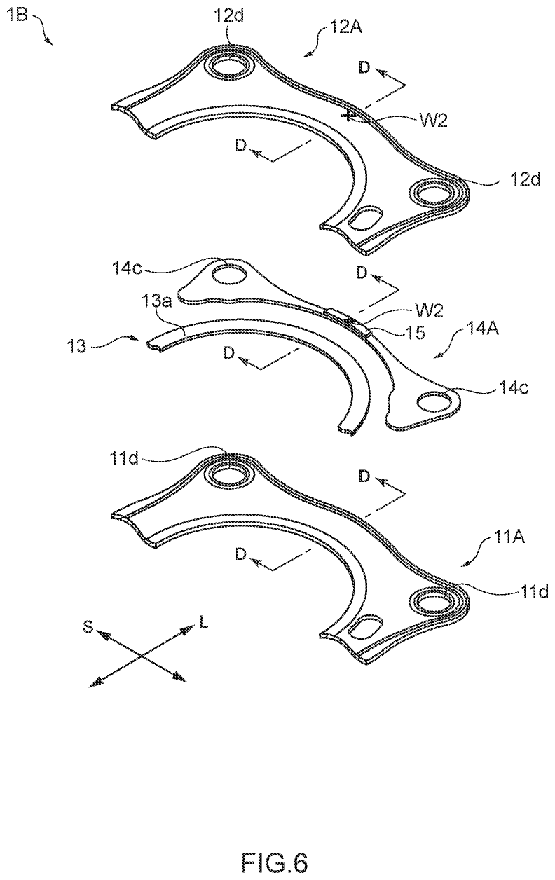

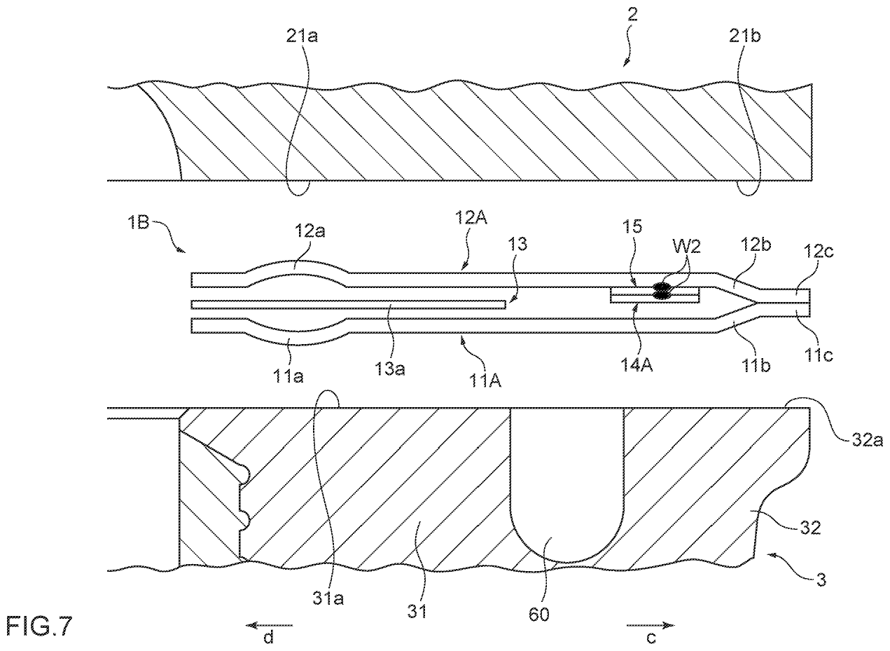

FIG. 6 is a schematic perspective view showing one end portion of a gasket 1B according to a modified example of the second embodiment of the present disclosure in the arrangement direction L. FIG. 7 is a cross-sectional view showing the gasket 1B along line D-D of FIG. 6, inclusive of a cylinder head 2 and a cylinder block 3. It should be noted that in FIGS. 6 and 7, portions corresponding to those in the first and second embodiments are denoted by the same reference signs as those in the first and second embodiments. Hereinafter, portions different from those in the first and second embodiments will be mainly described.

The gasket 1B according to the modified example of the second embodiment of the present disclosure is attached between the cylinder head 2 and the cylinder block 3 of the internal combustion engine. The gasket 1B includes a pair of substrates 11A and 12A, a shim plate (i.e., an intermediate plate) 13 disposed between the pair of substrates 11A and 12A, and a spacer 14A disposed between the pair of substrates 11A and 12A. The spacer 14A has an intermediate plate 15 as a protruding portion. The intermediate plate 15 is a metal member, for example, and is a part of the spacer 14A protruding toward the upper substrate 12A at an intermediate site along the cross direction S. The spacer 14A is fixed to the upper substrate 12A via the intermediate plate 15.

The intermediate plate 15 is specifically provided at the center or substantially the center of the spacer 14A along its extension direction (i.e., the cross direction S), and extends over a predetermined length along the cross direction S. In addition, the intermediate plate 15 has a shape such that it does not protrude inward or outward from the spacer 14A along the arrangement direction L, for example.

In the gasket 1B, if the lower substrate 11A and the upper substrate 12A are aftercoated, the spacer 14A is joined to the upper substrate 12A at a junction W2 via the intermediate plate 15. The upper substrate 12A, the intermediate plate 15, and the spacer 14A are joined together at the junction W2 through welding, such as spot welding, for example. It should be noted that the spacer 14A and the intermediate plate 15 are separate members, but may also be formed as an integral member. In addition, the intermediate plate 15 may be disposed between the lower substrate 11A and the spacer 14A. In this manner, the spacer 14A is fixed to the upper substrate 12A via the intermediate plate 15, which facilitates the attachment of the gasket 1B.

The gasket 1B according to the present modified example functions in a manner similar to the aforementioned gasket 1A according to the second embodiment of the present disclosure in the usage state, and with the gasket 1B according to the modified example, deformation of the cylinder head 2 due to the fastening force of the bolts 40 and 41 can be suppressed.

### Third Embodiment

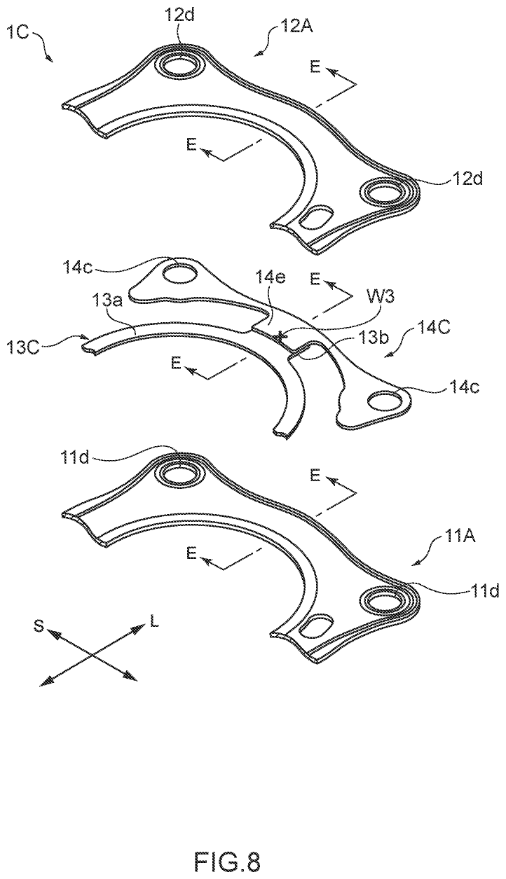

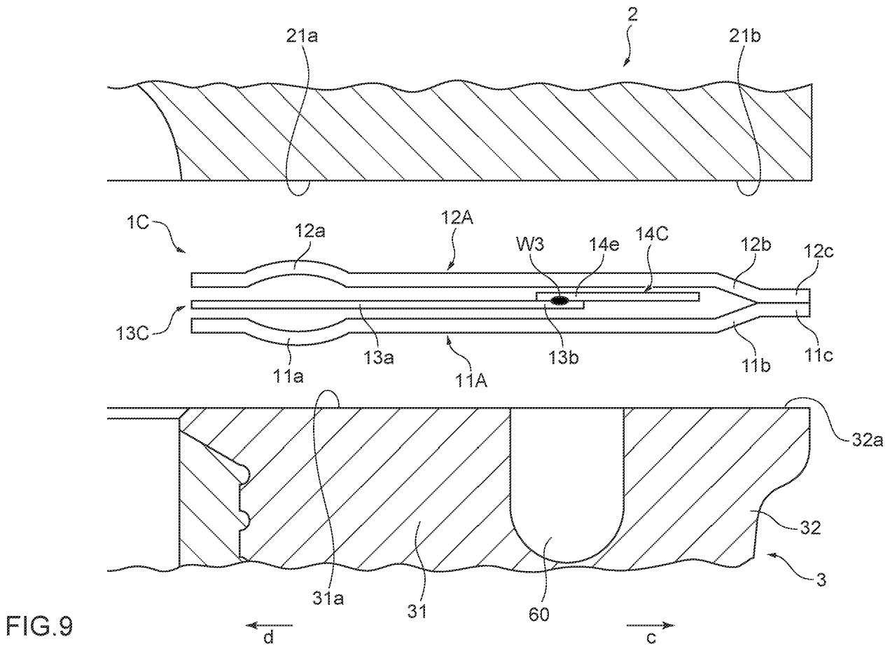

FIG. 8 is a schematic perspective view showing one end portion of a gasket 1C according to a third embodiment of the present disclosure in the arrangement direction L. FIG. 9 is a cross-sectional view of the gasket 1C along line E-E of FIG. 8, inclusive of a cylinder head 2 and a cylinder block 3. It should be noted that in FIGS. 8 and 9, portions corresponding to those in the first and second embodiments are denoted by the same reference signs as those in the first and second embodiments. Hereinafter, portions different from those in the first and second embodiments will be mainly described.

The gasket 1C according to the third embodiment of the present disclosure is attached between the cylinder head 2 and the cylinder block 3 of the internal combustion engine. The gasket 1C includes a pair of substrates 11A and 12A, a shim plate (i.e., an intermediate plate) 13C disposed between the pair of substrates 11A and 12A, and a spacer 14C disposed between the pair of substrates 11A and 12A.

The shim plate 13C has an overhanging portion (i.e., an intermediate-plate overhanging portion) 13b. The overhanging portion 13b is provided on each of wedge portions 13a located at opposite ends in the arrangement direction L, and is formed so as to extend in the arrangement direction L from a portion in the circumferential direction of each of the wedge portions 13a at the opposite ends. The two overhanging portions 13b extend in directions away from each other (i.e., outward).

The overhanging portion 13b is formed in a substantially rectangular shape. The overhanging portion 13b extends outward such that it has a constant or substantially constant width along the circumferential direction of the wedge portion 13a, for example. It should be noted that the overhanging portion 13b may be a member with a shape such that its width along the circumferential direction of the wedge portion 13a changes toward the outer side. The overhanging portion 13b is formed integrally with the wedge portion 13a. It should be noted that the overhanging portion 13b may be separate from the wedge portion 13a.

The spacer 14C has an overhanging portion (i.e., a spacer overhanging portion) 14e. In the gasket 1C, the overhanging portion 14e is formed so as to extend inward in the arrangement direction L. The overhanging portion 14e is formed in a substantially rectangular shape. The overhanging portion 14e extends inward such that it has a constant or substantially constant width along the cross direction S intersecting the arrangement direction L, for example. It should be noted that the overhanging portion 14e may be a member with a shape such that its width changes along the extension direction of the spacer 14C.

In the gasket 1C, the shim plate 13C and the spacer 14C are joined together at a junction W3. Specifically, the overhanging portion 13b of the shim plate 13C and the overhanging portion 14e of the spacer 14C are joined together at the junction W3 through welding, such as spot welding, for example. The overhanging portion 13b of the shim plate 13C is joined to the overhanging portion 14e of the spacer 14C via a surface of the overhanging portion 13b facing the upper substrate 12A as illustrated in FIGS. 8 and 9. The overhanging portion 14e of the spacer 14C may be joined to the overhanging portion 13b of the shim plate 13C via not the surface of the overhanging portion 13b facing the upper substrate 12A but a surface of the overhanging portion 13b facing the lower substrate 11A.

In the usage state of the gasket 1C, the overhanging portion 13b of the shim plate 13C protrudes to the side of the cooling water passage 60. The shim plate 13C is located such that the overhanging portion 13b faces the cooling water passage 60. Specifically, the tip end of the overhanging portion 13b of the shim plate 13C does not extend outward beyond the cooling water passage 60 in the arrangement direction L. That is, the overhanging portion 13b of the shim plate 13C is formed so as not to reach the cooling water sealing bead 11b of the lower substrate 11A or the cooling water sealing bead 12b of the upper substrate 12A (i.e., so as to end in front of the cooling water sealing bead 11b and the cooling water sealing bead 12b). It should be noted that the wedge portion 13a does not overlap the cooling water passage 60. Further, the spacer 14C is located such that the overhanging portion 14e faces the cooling water passage 60. The spacer 14C protrudes to the side of the cooling water passage 60 at the position of the overhanging portion 14e, but portions of the spacer 14C other than the overhanging portion 14e do not overlap the cooling water passage 60 on the inner side in the arrangement direction L. In addition, in the usage state of the gasket 1C, the junction W3 where the overhanging portion 13b of the shim plate 13C and the overhanging portion 14e of the spacer 14C are joined together along the arrangement direction L faces the cooling water passage 60. In this manner, the spacer 14C and the shim plate 13C are fixed together via the overhanging portions 14e and 13b, which facilitates the attachment of the gasket 1C.

The gasket 1C according to the third embodiment of the present disclosure functions in a manner similar to the aforementioned gasket 1 according to the first embodiment of the present disclosure in the usage state, and thus, deformation of the cylinder head 2 due to the fastening force of the bolts 40 and 41 can be suppressed.

### Modified Example of Third Embodiment

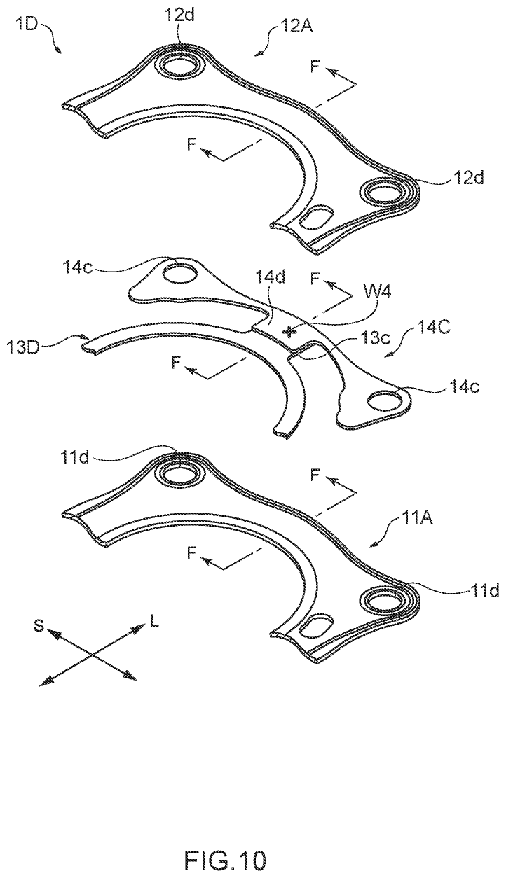

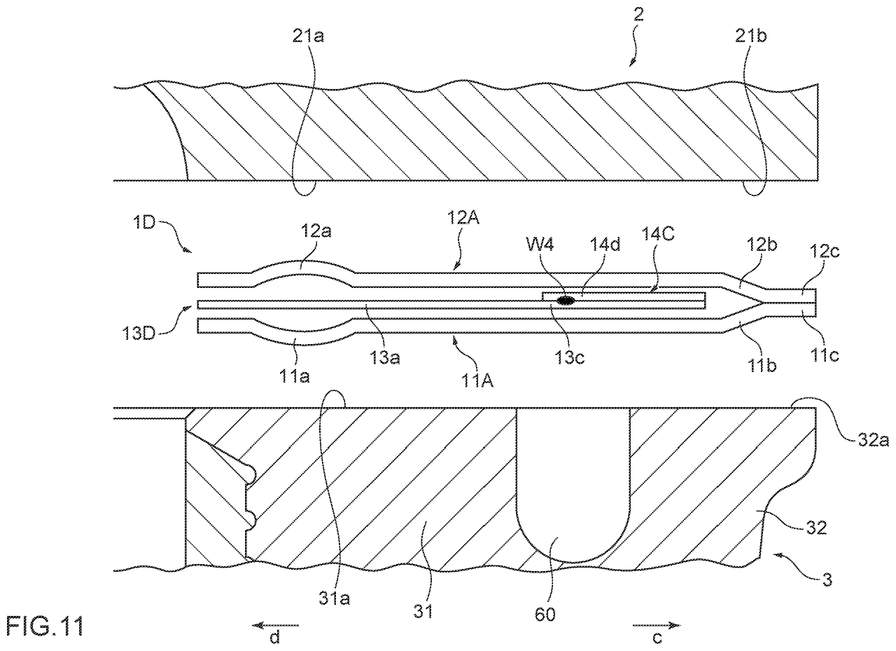

FIG. 10 is a schematic perspective view showing an end portion at one end of a gasket 1D according to a modified example of the third embodiment of the present disclosure in the arrangement direction L. FIG. 11 is a cross-sectional view showing the gasket 1D along line F-F of FIG. 10, inclusive of a cylinder head 2 and a cylinder block 3. It should be noted that in FIGS. 10 and 11, portions corresponding to those in the first, second, and third embodiments are denoted by the same reference signs as those in the first, second, and third embodiments. Hereinafter, portions different from those in the first, second, and third embodiments will be mainly described.

The gasket 1D according to the modified example of the third embodiment of the present disclosure differs from the aforementioned gasket 1C in the configuration of the overhanging portion of the shim plate. Specifically, a shim plate 13D of the gasket 1D differs from the shim plate 13C of the gasket 1C in the shape of the overhanging portion, and has an overhanging portion (i.e., an intermediate-plate overhanging portion) 13c. The overhanging portion 13c is formed in a substantially rectangular shape. The overhanging portion 13c is formed so as to extend in the arrangement direction L from a portion in the circumferential direction of each of wedge portions 13a located at opposite ends in the arrangement direction L. The two overhanging portions 13c extend in directions away from each other (i.e., outward). The overhanging portion 13c is formed integrally with the wedge portion 13a. The shim plate 13D and the spacer 14C are joined together at a junction W4. Specifically, the overhanging portion 13c of the shim plate 13D and the overhanging portion 14e of the spacer 14C are joined together at the junction W4 through welding, such as spot welding, for example.

In the usage state of the gasket 1D, the overhanging portion 13c of the shim plate 13D extends outward beyond the cooling water passage 60 in the arrangement direction L. In the arrangement direction L, an end portion (i.e., a tip end) on the outer side of the overhanging portion 13c of the shim plate 13D reaches an end portion on the outer side of the spacer 14C. In addition, the overhanging portion 13c of the shim plate 13D is formed so as not to reach the cooling water sealing bead 11b of the lower substrate 11A and the cooling water sealing bead 12b of the upper substrate 12A (i.e., so as to end in front of the cooling water sealing bead 11b and the cooling water sealing bead 12b). Further, in the arrangement direction L, the range in which the shim plate 13D and the spacer 14C overlap each other extends to the outer side of the cooling water passage 60. In the usage state of the gasket 1D, the junction W4 where the overhanging portion 13c of the shim plate 13D and the overhanging portion 14e of the spacer 14C are joined together along the arrangement direction L faces the cooling water passage 60. In this manner, the spacer 14C and the shim plate 13D are fixed together via the overhanging portions 14e and 13c, which facilitates the attachment of the gasket 1D.

The gasket 1D according to the present modified example functions in a manner similar to the aforementioned gasket 1 according to the first embodiment of the present disclosure in the usage state, and thus, deformation of the cylinder head 2 due to the fastening force of the bolts 40 and 41 can be suppressed.

### Fourth Embodiment

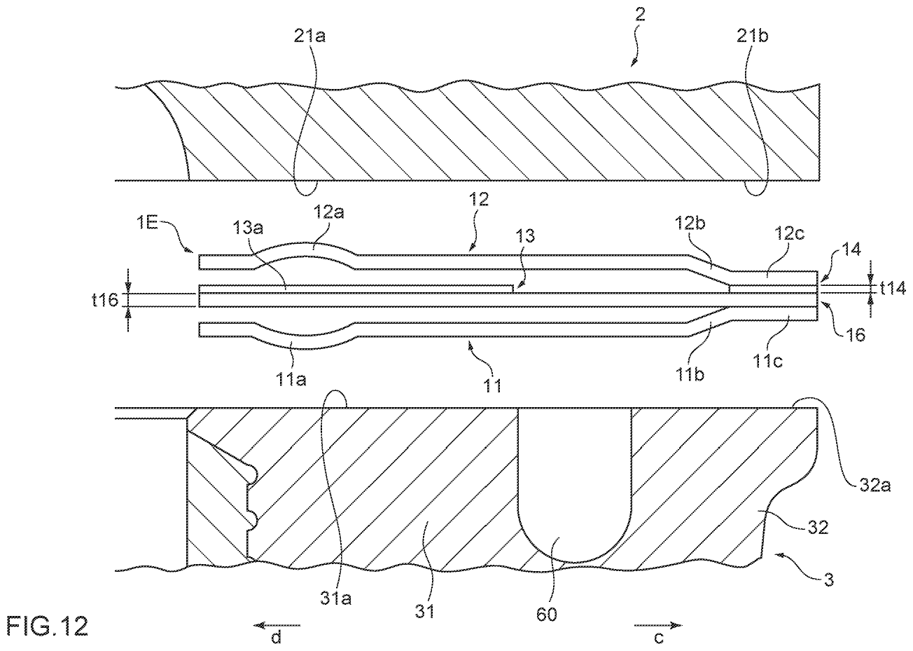

FIG. 12 is a cross-sectional view showing an internal combustion engine provided with a gasket 1E according to a fourth embodiment of the present disclosure, inclusive of a cylinder head 2 and a cylinder block 3. It should be noted that in FIG. 12, portions corresponding to those in FIG. 2 are denoted by the same reference signs as those in FIG. 2. Hereinafter, portions different from those in the first, second and third embodiments will be mainly described. The gasket 1E according to a fourth embodiment includes a pair of substrates 11 and 12, a flat intermediate plate (hereinafter also referred to as a “shim intermediate plate”) 16 disposed between the pair of substrates 11 and 12, a shim plate 13, and a spacer 14 disposed between the pair of substrates 11 and 12. It should be noted that the spacer 14 in the first embodiment is used in the gasket 1E according to the fourth embodiment, but the spacer 14A in the second embodiment or the spacer 14C in the third embodiment may also be used.

The shim intermediate plate 16 is disposed between the lower substrate 11 and the shim plate 13. The shim intermediate plate 16 is a member formed in substantially the same shape as the lower substrate 11 and the upper substrate 12. The shim intermediate plate 16 has bolt holes, oil holes, cooling water holes, and the like (not illustrated) corresponding to the insertion holes 11d and 11e and the insertion holes 12d and 12e as appropriate according to the configurations of the lower substrate 11 and the upper substrate 12.

The thickness (i.e., plate thickness) t14 of the spacer 14 may be the same or substantially the same as the thickness (i.e., plate thickness) t16 of the shim intermediate plate 16, or may be thinner than the thickness (i.e., plate thickness) t16 of the shim intermediate plate 16 (t14<t16). Since the configuration of the shim intermediate plate 16 is publicly known, the detailed description thereof is omitted herein. It should be noted that the shim intermediate plate 16 may be disposed between the upper substrate 12 and the shim plate 13. Herein, the thickness t16 of the shim intermediate plate 16 is the width (i.e., dimension) between a surface of the shim intermediate plate 16 facing the lower substrate 11 and a surface thereof facing the upper substrate 12.

Next, the function of the aforementioned gasket 1E according to the fourth embodiment will be described. In the usage state of the gasket 1E, the shim plate 13 is sandwiched between the shim intermediate plate 16 and the cylinder head 2, between a cylinder head surface 21a and a deck surface 31a. The spacer 14 is sandwiched between the shim intermediate plate 16 and the upper substrate 12, between an outer upper surface 32a of the cylinder block 3 and an outer lower surface 21b of the cylinder head 2.

The gasket 1E formed as an integral body in this manner is placed on a predetermined position of the cylinder block 3. Specifically, the gasket 1E is placed such that a cooling water sealing bead 11b of the lower substrate 11 is disposed on the outer upper surface 32a of the cylinder block 3 and each bead 11a of the lower substrate 11 is disposed on the deck surface 31a of each bore wall 31. Positioning of the gasket 1E with respect to the cylinder block 3 is carried out as in the aforementioned first embodiment.

In the usage state of the gasket 1E, the gasket 1E achieves a desired sealing function. In the usage state of the gasket 1E, as the lower substrate 11 and the upper substrate 12 are sandwiched with the shim intermediate plate 16 and the shim plate 13 interposed therebetween, the seal performance for boreholes 31b can be improved.

Further, in the usage state of the gasket 1E, the spacer 14 functions in a manner similar to the spacer 14 of the aforementioned gasket 1 between the outer lower surface 21b of the cylinder head 2 and the outer upper surface 32a of the cylinder block 3. Therefore, non-uniform deformation of the cylinder head 2 at opposite ends in the arrangement direction L can be suppressed, and thus, generation of fastening strain in the cylinder head 2 can be suppressed. This can suppress a decrease in the sealing performance for the gap between the cylinder head 2 and the cylinder block 3.

It should be noted that the insertion holes 11d of the lower substrate 11, the insertion holes 12d of the upper substrate 12, and the insertion holes 14c of the spacer 14 may be formed either on the inner side or the outer side of the cooling water sealing beads 11b and 12b.

As described above, with the gasket 1E according to the fourth embodiment of the present disclosure, deformation of the cylinder head 2 due to the fastening force of the bolts 40 and 41 can be suppressed.

### Fifth Embodiment

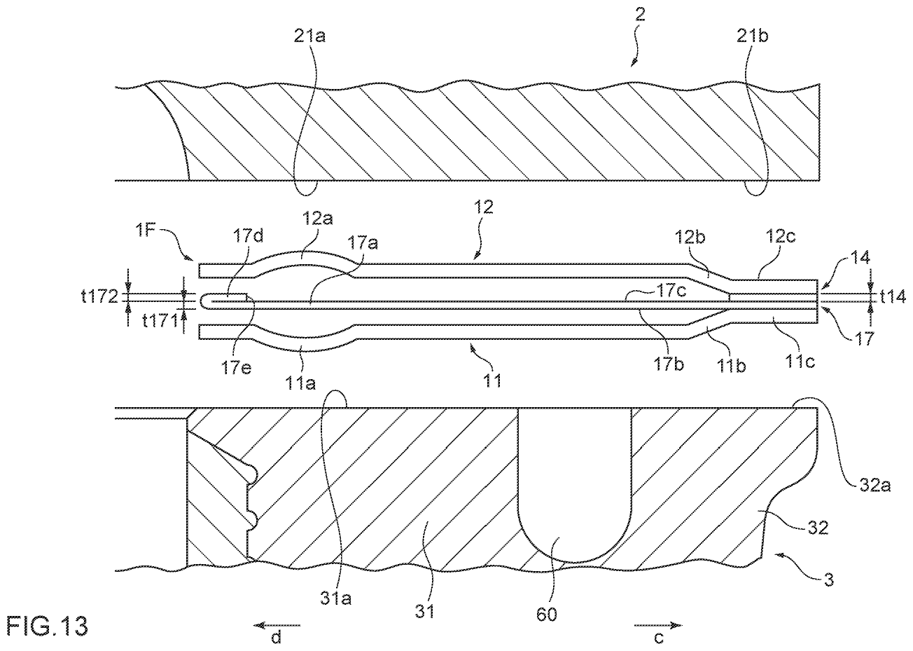

FIG. 13 is a cross-sectional view of an internal combustion engine provided with a gasket 1F according to a fifth embodiment of the present disclosure, inclusive of a cylinder head 2 and a cylinder block 3. It should be noted that in FIG. 12, portions corresponding to those in FIG. 2 are denoted by the same reference signs as those in FIG. 2. Hereinafter, portions different from those in the first, second, third and fourth embodiments will be mainly described. The gasket 1F according to the fifth embodiment includes a pair of substrates 11 and 12, an intermediate plate (hereinafter also referred to as a “shim plate”) 17 disposed between the pair of substrates 11 and 12, and a spacer 14 disposed between the pair of substrates 11 and 12. It should be noted that the spacer 14 in the first embodiment is used in the gasket 1F according to the fifth embodiment, but the spacer 14A in the second embodiment or the spacer 14C in the third embodiment may also be used.

The shim plate (i.e., the intermediate plate) 17 is a member formed in substantially the same shape as the lower substrate 11 and the upper substrate 12. The shim plate 17 has a wedge portion 17a. The wedge portion 17a is an annular portion around a borehole 31b defined by a bore wall 31. The wedge portion 17a has a portion located between a bead 11a of the lower substrate 11 and a bead 12a of the upper substrate 12. The wedge portion 17a has a folded portion 17d.

The folded portion 17d is formed in an annular shape so as to extend around the borehole 31b defined by the bore wall 31 in the usage state of the gasket 1F. The folded portion 17d is located between the bead 11a of the lower substrate 11 and the bead 12a of the upper substrate 12 and on the inner side of the bead 11a of the lower substrate 11 and the bead 12a of the upper substrate 12. It should be noted that the folded portion 17d is a portion obtained by folding an end portion on the inner periphery side of the wedge portion 17a, and is specifically a portion obtained by folding an end portion on the inner periphery side of the shim plate 17 such that it is located on the inner periphery side of the deck surface 31a, for surrounding the borehole 31b, in the usage state of the gasket 1F.

The thickness (i.e., plate thickness) t14 of the spacer 14 may be the same or substantially the same as the thickness (i.e., plate thickness) t171 of the wedge portion 17a or the thickness (i.e., plate thickness) t172 of the folded portion 17d, or may be thinner than the thickness t171 of the wedge portion 17a or the thickness t172 of the folded portion 17d (t14<t171 or t14<t172). Herein, the thickness t171 of the wedge portion 17a is the width (i.e., dimension) between a surface (i.e., a lower surface 17b) of the wedge portion 17a excluding the folded portion 17d and facing the lower substrate 11 and a surface (i.e., an upper surface 17c) thereof facing the upper substrate 12. In addition, the thickness t172 of the folded portion 17d is the width (i.e., dimension) between the lower surface 17b and the upper surface 17c of the folded portion 17d.

In addition, the folded portion 17d extends such that an end portion 17e that is an end portion on the outer side of the folded portion 17d does not overlap the bead 11a of the lower substrate 11 or the bead 12a of the upper substrate 12. It should be noted that the shim plate 17 is a member formed in substantially the same shape as the lower substrate 11 and the upper substrate 12, and has bolt holes, oil holes, cooling water holes, and the like corresponding to the insertion holes 11d and the insertion holes 12d as appropriate according to the configurations of the lower substrate 11 and the upper substrate 12.

Next, the function of the aforementioned gasket 1F will be described. The spacer 14 is disposed between an outer edge portion 11c of the lower substrate 11 and an outer edge portion 12c of the upper substrate 12 such that it does not overlap a cooling water sealing bead 11b of the lower substrate 11 or a cooling water sealing bead 12b of the upper substrate 12. In addition, the shim plate 17 is disposed between the lower substrate 11 and the upper substrate 12 such that the end portion 17e of the folded portion 17d does not overlap the bead 11a of the lower substrate 11 or the bead 12a of the upper substrate 12.

The gasket 1F formed as an integral body in this manner is placed on a predetermined position of the cylinder block 3. Specifically, the gasket 1F is placed such that the cooling water sealing bead 11b of the lower substrate 11 faces an outer upper surface 32a of the cylinder block 3, and each bead 11a of the lower substrate 11 faces the deck surface 31a of each bore wall 31. Positioning of the gasket 1F with respect to the cylinder block 3 is carried out as in the aforementioned first embodiment.

In the usage state of the gasket 1F, the gasket 1F achieves a desired sealing function. In the usage state of the gasket 1F, as the lower substrate 11 and the upper substrate 12 are sandwiched with the shim plate 17 at the portion of its folded portion 17d interposed therebetween, the seal performance for boreholes 31b can be improved.

Further, in the usage state of the gasket 1F, the spacer 14 functions in a manner similar to the spacer 14 of the aforementioned gasket 1 between the outer lower surface 21b of the cylinder head 2 and the outer upper surface 32a of the cylinder block 3. Therefore, non-uniform deformation of the cylinder head 2 at opposite ends in the arrangement direction L can be suppressed, and thus, generation of fastening strain in the cylinder head 2 can be suppressed. This can suppress a decrease in the sealing performance for the gap between the cylinder head 2 and the cylinder block 3.

It should be noted that the insertion holes 11d of the lower substrate 11, the insertion holes 12d of the upper substrate 12, and the insertion holes 14c of the spacer 14 may be formed either on the inner side or the outer side of the cooling water sealing beads 11b and 12b.

As described above, with the gasket 1F according to the fifth embodiment of the present disclosure, deformation of the cylinder head 2 due to the fastening force of the bolts 40 and 41 can be suppressed.

Although the first, second, third, fourth and fifth embodiments have been described above, the present disclosure is not limited to the gasket 1 according to the first embodiment, the gasket 1A or 1B according to the second embodiment, the gasket 1C or 1D according to the third embodiment, the gasket 1E according to the fourth embodiment, or the gasket 1F according to the fifth embodiment, and includes all aspects encompassed by the concept and the claims of the present disclosure. In addition, the aforementioned configurations may be selectively combined as appropriate so as to achieve at least some of the aforementioned object and effects. For example, the shape, material, arrangement, size, and the like of each component in each of the aforementioned embodiments may be changed as appropriate depending on a specific usage pattern of the present disclosure. For example, the spacer 14 in the first embodiment may be attached to at least one of the lower substrate 11 and the upper substrate 12 at the outer edge portions 11c and 12c on the outer side of the cooling water sealing bead 11b of the lower substrate 11 and the cooling water sealing bead 12b of the upper substrate 12, respectively, in the arrangement direction L. Specifically, the spacer 14 may be attached to only the lower substrate 11, only the upper substrate 12, or both the lower substrate 11 and the upper substrate 12.

What is claimed is:

1. A gasket to be attached between a cylinder head and a cylinder block of an internal combustion engine, comprising:
a pair of substrates;
an intermediate plate disposed between the pair of substrates; and
a spacer disposed between the pair of substrates,
wherein:
each of the pair of substrates includes a cooling water sealing bead as a bead portion for sealing a cooling water passage surrounding a bore wall formed in the cylinder block,
the intermediate plate includes a wedge portion as a portion formed in a shape corresponding to a deck surface of the bore wall of the cylinder block so as to be sandwiched between the bore wall and the cylinder head, and
the spacer is formed so as to extend in a cross direction crossing an arrangement direction of boreholes of the cylinder block without overlapping the cooling water sealing bead, and be sandwiched between the cylinder block and the cylinder head at each end in the arrangement direction of the boreholes.

2. The gasket according to claim 1, wherein a plate thickness of the spacer is less than or equal to a plate thickness of the wedge portion of the intermediate plate.

3. The gasket according to claim 1, wherein the spacer at each end has a pair of through-holes opposed in the cross direction, the pair of through-holes corresponding to a pair of bolt holes of the cylinder head and a pair of bolt holes of the cylinder block.

4. The gasket according to any one of claim 1, wherein the spacer is fixed to at least one of the pair of substrates through riveting or swaging.

5. The gasket according to any one of claim 1, wherein the spacer is joined to one of the pair of substrates.

6. The gasket according to claim 5,
wherein:
the spacer is provided with a protruding portion at an intermediate site along an extension direction of the spacer, the protruding portion being a portion protruding toward one of the pair of substrates, and
the spacer is joined to the one of the pair of substrates at the protruding portion.

7. The gasket according to any one of claim 1,
wherein:
the intermediate plate includes an intermediate-plate overhanging portion as a portion protruding to a side of the cooling water passage, and
the spacer is joined to the intermediate-plate overhanging portion.

8. The gasket according to claim 7,
wherein:
the spacer includes a spacer overhanging portion as a portion protruding to the side of the cooling water passage,
the intermediate plate and the spacer are joined together at the intermediate-plate overhanging portion and the spacer overhanging portion, and
a portion where the intermediate-plate overhanging portion and the spacer overhanging portion are joined together overlaps the cooling water passage.

9. The gasket according to claim 7, wherein the intermediate-plate overhanging portion extends beyond the cooling water passage.
